(19) United States
(12) Patent Application Publication
(10) Pub. No.: US 2008/0082366 A1
(43) Pub. Date: Apr. 3, 2008

(54) Automated Medical Treatment Order Processing System

(75) Inventors: Theresa M. Miller, Downingtown, PA (US); Amadeo De Jesus, Coatesville, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., MALVERN, PA (US)

(21) Appl. No.: 11/865,918

(22) Filed: Oct. 2, 2007

Related U.S. Application Data
(60) Provisional application No. 60/827,758, filed on Oct. 2, 2006.
(60) Provisional application No. 60/952,607, filed on Jul. 30, 2007.

(51) Int. Cl. G06Q 10/00; G06F 17/30; G06Q 50/00; G06F 17/40

(52) U.S. Cl. 705/3; 705/2

(57) ABSTRACT

A system employs a workflow engine and rules engine to automatically create, activate, discontinue, or perform other clinical orders functions without requiring a clinical user's interaction to initiate the orders. This facilitates advanced clinical workflow order automation, allowing to implement treatment protocols as automated system processes that improve clinical system processes efficiencies and the quality of patient care.

This is a nonprovisional application of provisional application Ser. No. 60/827,758 filed Oct. 2, 2006 and of Ser. No. 60/952,607 filed Jul. 30, 2007 by Theresa Miller and Amadeo DeJesus.

### FIELD OF THE INVENTION

The present invention relates to healthcare information systems, and more particularly relates to an automated treatment ordering system.

### BACKGROUND OF THE INVENTION

Healthcare information systems are known, including computerized physician order entry (CPOE) systems. CPOE systems process patient treatment orders for healthcare facilities operating such systems. After configuration, known systems provide ordering physicians with an ability to enter orders at a system interface. The system interface presents interactive display images that enable order entry. The system responds to user manual input to initiate order workflow, but a user needs to create, activate and discontinue treatment orders manually. Healthcare facility workers such as nurses, therapists, various physicians, pharmacy and laboratory workers, radiologists and radiology support staff and technicians, etc., respond to the order where necessary and carry out associated order tasks.

In known systems, treatment ordering processes are put in place by configuring a complex order workflow engine that defines appropriate paths for each automatic callback relating to an order. Healthcare facility policy embodies rules controlling order processing. As configured, the known systems provide workflow processes that allow physicians and other system users to manually create an order as one event, or in one ordering session, but require another manual access or user event to activate or discontinue the order. At order activation, known systems implement messaging to alert various healthcare workers to respond to the order. Conventional ordering workflow requiring manual processing to initiate or modify every treatment order places a burden on healthcare facility workers by an increased workflow, and increases system workload.

An automated treatment ordering system addressing these deficiencies and related problems will valuably advance the related arts.

### SUMMARY OF THE INVENTION

To that end, the present invention discloses an automated medical treatment ordering system that implements clinical orders advanced workflow processes. The advanced workflow processes automatically initiate and discontinue clinical orders without requiring manual clinician interaction, such as with automatic ancillary orders placement. The term orders is used broadly to mean clinical orders and other healthcare-related service requests including without limitation medical activity treatment orders such as medication orders, admission orders, discharge orders, surgical orders, radiological orders, nursing treatment orders, dietary treatment orders, activity service requests, etc. The automated treatment ordering system is configured to operate the orders advanced workflow processes in accordance with facility (hospital) policies, protocols and procedures, as embodied in a set of ordering control rules. The rules drive a rules-based workflow engine to interact with an orders auto place/update service application program interface that integrates automatic ordering processes with system Output order processing functions.

In one embodiment, the system integrates the following functional components: a workflow engine, a rules engine, an orders auto place/update service application program interface (API) that includes a call back strategies function and a standard order parameters function, and an Output order processing function. The terms function, process and application are used interchangeably herein as appropriate. Once configured, the API, with the call back strategies and standard order parameters functions operate the workflow engine and a rules engines to execute the automatic ancillary ordering workflow, without additional manual user interaction. The system configuration determines the workflow and rules engines triggers to integrate the various order functions, including at times invoking and executing automatic order place functions, and associated automatic ancillary order workflow. Preconfigured orders, including those enabling automatic ancillary ordering are stored in a system repository.

In another embodiment, the automated treatment ordering system comprises at least one repository including information associating a plurality of orders for treatments, to be administered to a patient with corresponding ancillary treatment orders. An input processor receives data identifying initiation of a particular treatment order for a particular patient. A data processor uses the information within the repository to automatically identify and initiate an ancillary treatment order associated with the particular treatment order for the patient in response to predetermined rules and the data identifying initiation of the particular treatment order. A workflow processor automatically communicates a message to inform a healthcare worker of a task to be performed pursuant to the ancillary treatment order.

The data processor automatically identifies and initiates the ancillary treatment order, and the workflow processor automatically communicates the messages without human intervention by execution in accordance with the predetermined rules. The ancillary treatment orders comprise medication orders, admission orders, discharge orders, surgical orders, radiological orders, nursing treatment orders, dietary treatment orders, and activity requests, without limitation. The predetermined rules comprise hospital or facility policy. Preferably, the predetermined rules comprise at least one of, (a) hospital determined procedures, (b) hospital determined treatment protocols and (c) treatment safety standards. The data processor identifies a code representing the particular treatment order by parsing data fields of a record representing the particular treatment order, using the identified code to automatically identify the ancillary treatment order from the information in the at least one repository.

### BRIEF DESCRIPTION OF THE DRAWING FIGURES

In order that the manner in which the above recited and other advantages of the invention may be obtained, a more particular description of the invention briefly described above is rendered by reference to specific embodiments thereof that are illustrated in the appended drawings. Understanding that these drawings depict typical embodiments of the invention and are not therefore to be considered to be limiting of its scope, the invention is described and explained with additional specificity and detail through use of the accompanying drawings in which:

FIG. 1 is a schematic diagram of a healthcare information system of the invention;

FIG. 2 is functional diagram of a medical order processing system of the invention;

FIGS. 3A and 3B are functional flow diagrams depicting treatment order workflow processing of a system of the invention; and

FIG. 4 is an alternative embodiment of a medical order processing system of the invention.

### DETAILED DESCRIPTION OF THE INVENTION

An automated treatment ordering system provides various modes for generating and processing treatment orders, including automatic ancillary ordering in accord with a set of rules. The rules determine system triggers (events) and in some operating conditions invoke automatic ancillary order placement action asynchronously. The system is configurable by a user to enable automatic ordering of ancillary treatment orders. The configuration predefines treatment and other activity orders, including orders with corresponding ancillary orders, and stores the orders in a system repository. When a user enters an order with an ancillary order, the entry or save triggers an ancillary order workflow automatically, without requiring user intervention. For example, entry of an admission assessment order identifying a patient for a smoking risk triggers the system to automatically identify and initiate an ancillary smoking consultation order. Such automatic ancillary ordering is responsive to an “at risk” code field included in an admission order record, such as by a field XYZ=true (smoker at risk). If the “smoker at risk” field is set to true, at entry (parsing the entered record), the code automatically triggers the system to identify and initiate the ancillary smoking consult order, without additional manual user intervention. An order auto place/update service implements the automatic ordering workflow, and coordinates Output order processing including messaging to designated facility healthcare workers to automatically place the ancillary order on an alerts worklist.

An executable application, as used herein, comprises code or machine readable instructions for conditioning a processor to implement predetermined functions, such as those of an operating system, a context acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by a display processor and enabling user interaction with a processor or other device and associated data acquisition and processing functions. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application manipulates the UI display images in response to the signals received from the input devices. In this way, the user interacts with the display image using the input devices, enabling user interaction with the processor or other device.

The functions and process steps herein may be performed automatically or wholly or partially in response to user commands. An activity (including a step) performed automatically is performed in response to an executable instruction or device operation without user direct initiation of the activity. Workflow comprises a sequence of tasks performed by a device or worker or both. An object or data object comprises a grouping of data, executable instructions or a combination of both or an executable procedure.

A workflow management system is a software system that manages processes. It includes a process definition function that allows users to define a process to be followed, an event monitor, which captures events from a Healthcare Information System and communicates the results to the workflow management system. A processor in the Management System tracks which processes are running, for which patients, and what step needs to be executed next, according to a process definition. The management system includes a procedure for notifying clinicians of a task to be performed, through their worklists and a procedure for allocating and assigning tasks to specific users or specific teams. A document or record comprises a compilation of data in electronic form and is the equivalent of a paper document and may comprise a single, self-contained unit of information.

A workflow processor, as used herein, processes data to determine tasks to add to a task list, remove from a task list or modifies tasks incorporated on, or for incorporation on, a task list. A task list is a list of tasks for performance by a worker or device or a combination of both. A workflow processor may or may not employ a workflow engine. A workflow engine, as used herein, is a processor executing in response to predetermined process definitions that implement processes responsive to events and event associated data, for example, time limitations. The workflow engine implements processes in sequence and/or concurrently, responsive to event associated data to determine tasks for performance by a device, or worker, i.e., caregiver, and for updating task lists, e.g., alerts worklist, of a device and facility staff to include determined workflow tasks. A process definition is definable by a user and comprises a sequence of process steps including one or more, of start, wait, decision and task allocation steps for performance by a device and or facility staff, for example. An event is an occurrence affecting operation of a process implemented using a process definition.

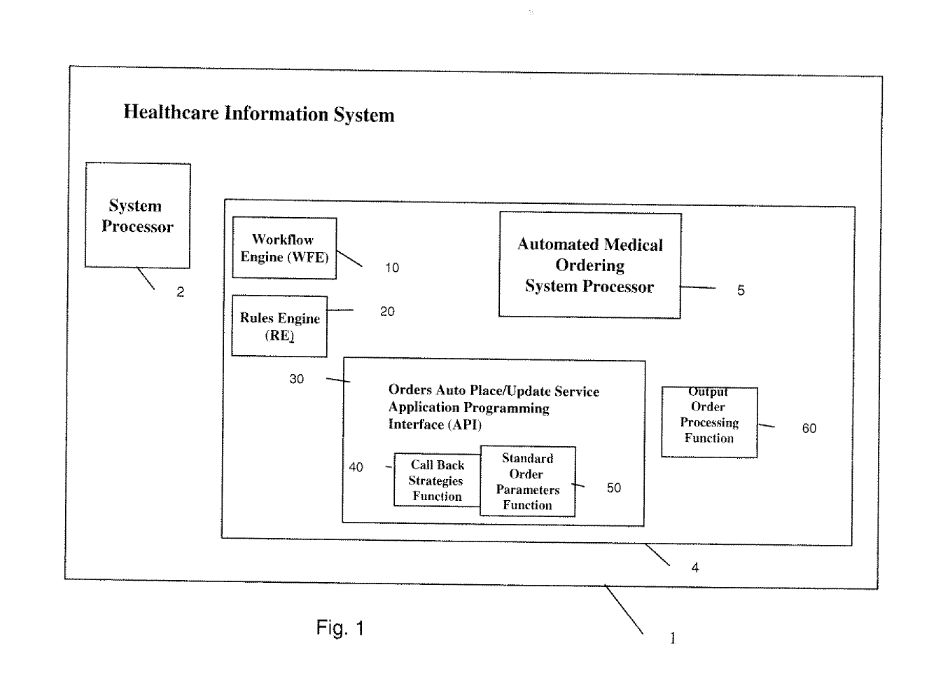

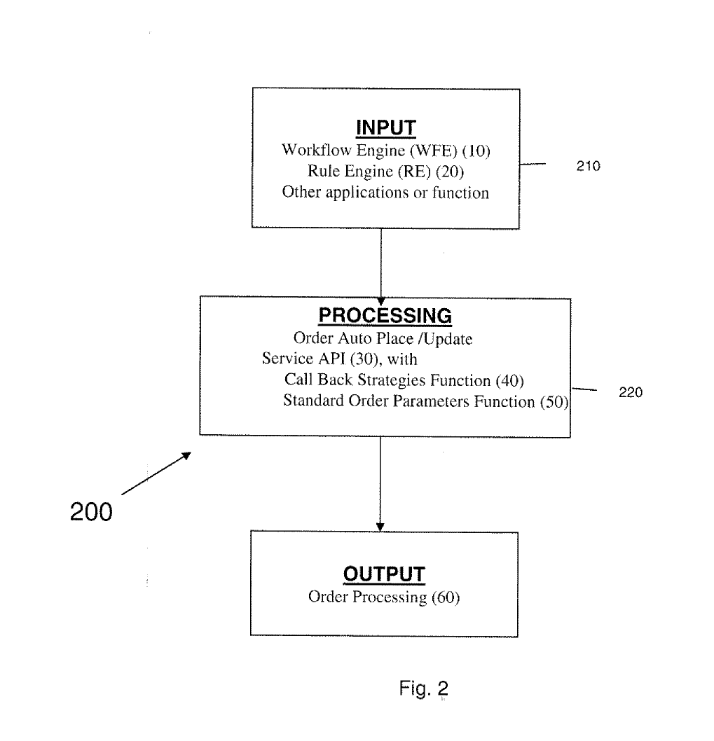

One embodiment of the invention comprises a healthcare information processing (HIS) system (1), as shown in FIG. 1 HIS system includes a system processor (2) and an automated medical treatment ordering system (4). Systems (4) comprises automated medical system processor (5), which cooperates with HIS system processor (2), and system ordering functions that intemperate to carry out intended ordering workflow. The ordering functions that implement ordering workflow are a workflow engine (10), a rules engine (20), and an orders auto place/update service application program interface, or API (30), and API call back strategies function (40) and standard order parameters function (50). Output order processing function (60) interacts with and responds to API operation in cooperation with the workflow engine and rules engine to coordinate the standard order parameters (50) and call back strategies (40) functions with the Output order processing function. The integrated operation optimizes (and standardizes) system ordering, and implements the automatic ancillary ordering operation.

The system is configured to track tasks associated with a treatment order, including those of any automatically initiated ancillary orders, to ensure that the tasks are completed, and in a timely manner. System operation is integrated and coordinated by use of the rules and API in response to events (e.g., entry of an admissions assessments (orders)); points of integration (e.g., a workflow operation by which data values are derived); and notifications (e.g., workflow operation by which inter-function messaging is carried out). In more detail, events trigger other events, and are themselves triggered by events. The rules designate events that are captured by the system, and trigger a workflow, or modify an active workflow. For example, entry of an admission assessment with a corresponding ancillary order triggers the workflow engine to initiate the ancillary order (i.e., an event) such as with the ancillary smoking consult order scenario described.

Events also trigger event steps within running order workflows, to modify the order or ancillary order. Notifications are generated in association with system order processing operation, and presented in a form of messages on various alerts worklist. Alerts worklists present to various system users, e.g., healthcare workers, designated treatment tasks requiring execution in accord with an active order (workflow), including suggestions how to complete the designated treatment tasks. Notification messaging is controlled by the workflow engine (10), and in coordination with API (30) for the automatic ancillary ordering operation.

The rules engine (RE) (20) enables the system to define and operate with a medical logic module. The RE medical logic module is invoked by the system in run time operation to provide decision support for implementing ordering operation. RE (20) is an independent functioning unit in a system health knowledge base, for example, such as a healthcare information system that is configured to operate as described herein. RE (20) embodies without limitation system maintenance information, system links to other sources of knowledge and logic to make a single healthcare-related decision if invoked in an HIS system workflow, for example.

API (30) controls system callback strategies function (40) and system standard order parameters function (50) coordinate and integrate automatic ordering workflow with the WFE (10) and RE (20), and the Output order processing function (60). API (30) and call back strategies function (40) provide success and failure messages with specific error, warning and information codes, enabling the WFE to respond and evaluate message responses to determine a next step in an order workflow, and overrides. That is, the call back strategies function enables the WFE (10) and RE (20) to interactively direct, override and redirect the workflow based on detected exception/error conditions, and messages.

The standard order parameters function (50) operates with the WFE (10) and RE (20) by coordinate by API (30). The WFE and RE send the standard order parameters function, via the API, parameter values required necessary for an order, e.g., patient name, visit, service (order) name, ordering party (“requested by”) and “entered by” designations for a worker, or by designating a free text protocol name, and order parameter value fields to identify frequency, order duration, dose, instructions, etc. The parameter values are defined in the workflow process by manual user entry, and are passed by the workflow engine from a preceding order process. The API (30) executes the automatic ordering workflow that supports the WFE (10) and RE (20) to automatically initiate and discontinue orders, e.g., ancillary orders, and to automatically modify active or existing orders in accord with healthcare facility protocols and policy. This system automatic ordering workflow does not require user intervention normally required by conventional systems to initiate orders and order changes.

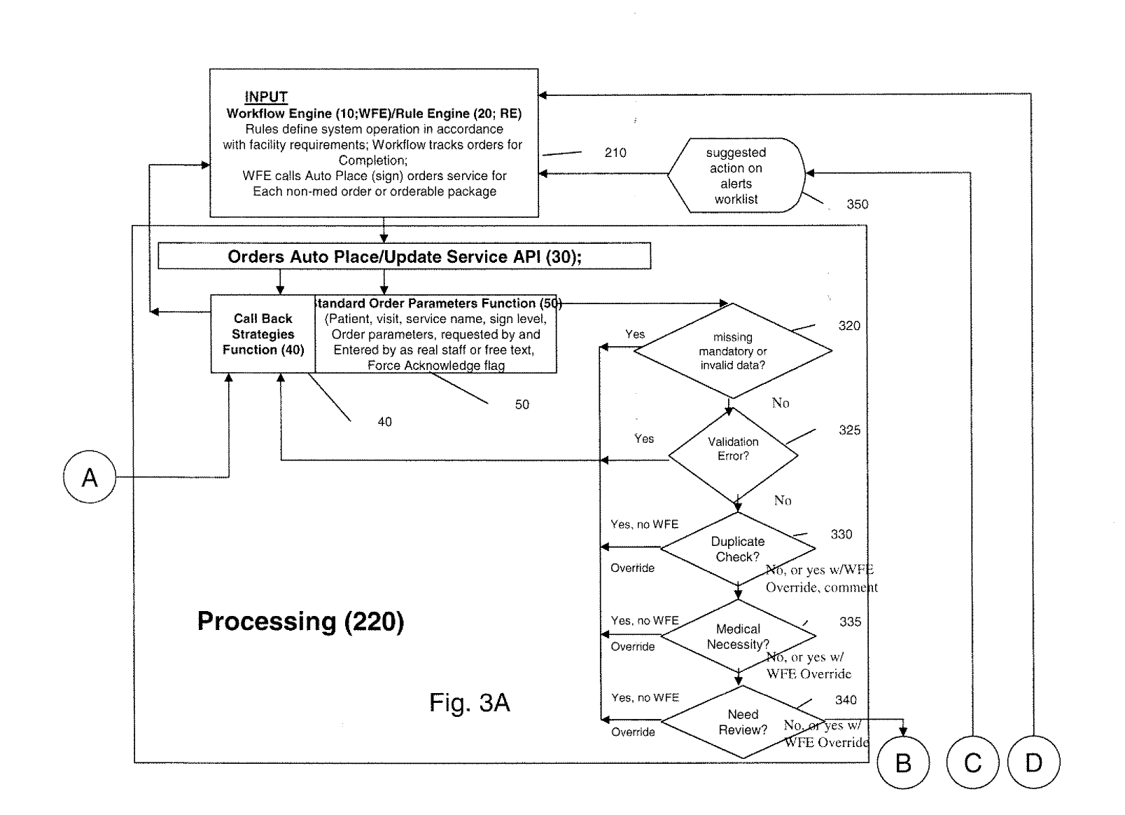

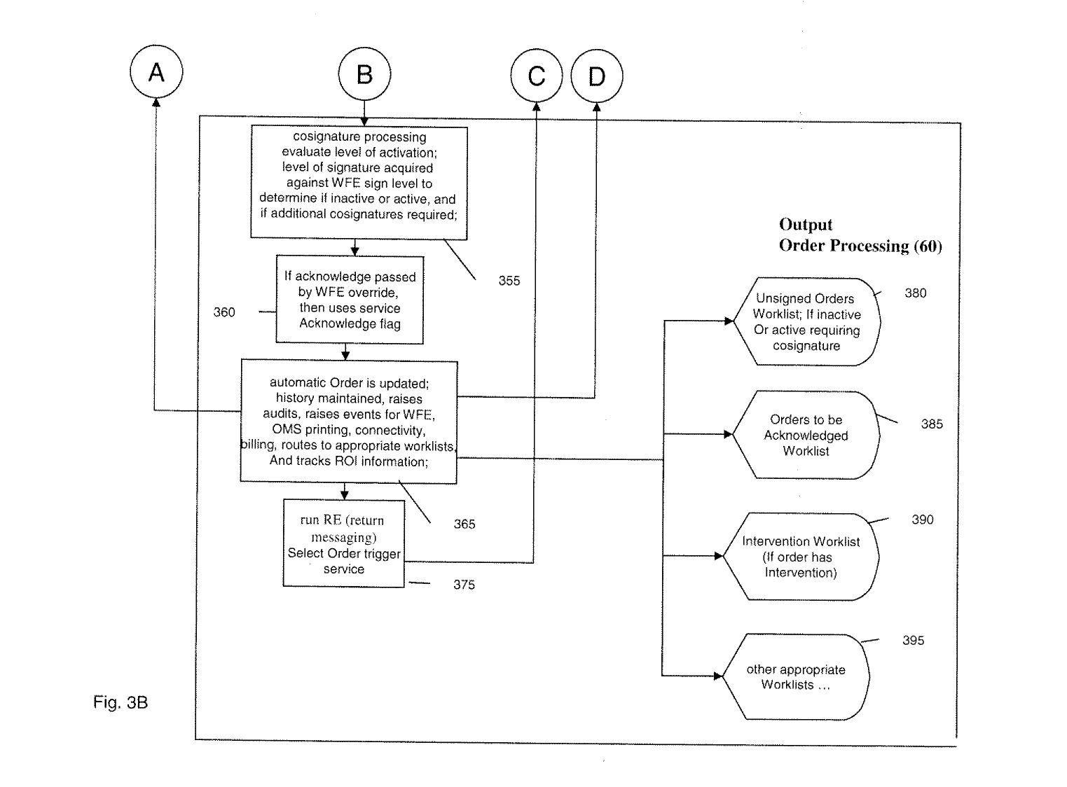

In the FIGS. 3A and 3B operating architecture, the WFE (10) and RE (20) track order workflow from creation or initiation to completion. The WFE operates with the API's order auto place service for non-medication-related ancillary orders, and orderable packages. The API's order auto place service workflow detects missing mandatory or invalid data values by a function represented by decision diamond (320). Where a mandatory data value is missing or invalid (YES), the system flow passes back to the call back strategies function (40). If the data is not missing or invalid (NO), the API order auto place service workflow the verifies for validation warnings or errors by a validation error check function represented by decision diamond (325). If validation warnings/errors are detected (YES), system flow passes to the call back strategies function (40). With no validation warnings/errors detected (NO), the API's order auto place service workflow detects whether the order is a duplicate order using a duplicate check function represented by decision diamond (330).

If a duplicate order is detected (YES), system flow passes to the call back strategies function (40) with no WFE override. If the order is not a duplicate (No), or if the order is a duplicate but the WEE has passed an acknowledge (Yes) for override, the API (30) order auto place service workflow determines whether the order includes a medical necessity code by a function represented by decision diamond (335). If the order is positive for medical necessity, and there is no WEE override, the system flow passes back to the call back strategies function. If the order is negative (No, or yes with WFE override) for medical necessity, the API order auto place service function determines if the order needs review by using a “need review” function represented by decision diamond (340). If the order needs review (YES), and there is no WFE override, system operation passes to the call back strategies function. If the order does not require review (No), or the WFE overrides (Yes with WFE override), system flows passes from the API order auto place service workflow to Output order processing function (60), as shown in FIG. 3B. A contiguous link from the API (30) to the FIG. 3B Output order processing function (60) is identified by connectors “B” in both FIGS. 3A and 3B.

At connector “B” in FIG. 3B, Output order processing function (60) is shown to include a cosignature processing function represented by block (355). The function carries out cosignature processing to evaluate an order's level of activation, its level of signature required against WFE (10) signature level to determine whether the order is active or inactive, and whether additional cosignatures are required. An override function (360) responds to acknowledge flags passed to it by the WE (10) to override the cosignature processing. If no acknowledge is passed by the WFE, the function uses a service acknowledge flag. In response, a function (365) updates the automatic order, maintains the automatic order history, initiates audits, initiates WFE action, OMS printing, connectivity, billing actions and routes to appropriate worklists, and tracks ROI information.

In more detail, function (365) operates with a function (350) (FIG. 3A) to suggest action for an automatically created order by messaging the WEE (10) and RE (20) to pass suggested actions to an alerts worklist. Connector “C” of FIG. 3B indicates a contiguous processing flow link through connector “C” of FIG. 3A to function (350), and the WEE and RE. Function (365) also provides for return messaging to the WFE (10) and RE (20), the contiguous flow path indicated by connector “D” in FIG. 3B, to the WFE (10) and RE (20) via connector “D” in FIG. 3A. The automatic order trigger function (365) also passes back a success with order ID to the Call Back Strategies function (40) (FIG. 3A) represented by connector “A,” in both FIGS. 3B and 3A. Function (365) further operates an unsigned orders function (380), by which inactive orders and orders that are active but require a cosignature are placed on an unsigned orders worklist. Function (385) operates an “orders to be acknowledged” worklist, where orders await acknowledges from the WFE (10). Function (390) is an intervention worklist function, which places orders with interventions on an intervention worklist. Function (395) is an “other” worklists function for placing orders on “other” worklists, where necessary for the automatic order workflow. By these supporting functions, function (365) tracks the “requested by” and order ID from the originating WFE process that initiates an ancillary order. A RE (20) select service (order) trigger function (375) with background indicator or the return messaging.

In one embodiment, the orders auto place/update service API (30) is written in an interactive messaging service format (e.g., MXS) to provide and enable complex WFE (10) and RE (20) interaction necessary between a caller process and other ordering functions. As described, the API calls applications or processes (Output order processing) to sufficiently support full background order workflow, including for ancillary orders without user intervention. The API provides background interactive messaging to perform necessary clinical checking to support the messaging back to WFE so that the workflow can make further order workflow decisions, for example, to decide whether to continue or to discontinue an order workflow. The messaging back is implemented using the call back strategies function (40).

Examples of order parameters include without limitation an identification of a patient, a visit, a service (order) name, an ordering party (requested by) and “entered by” values for staff or free text protocol name, frequency, order duration, dose, other instructions, etc. As described, order parameter value fields are defined in the workflow process by a GUI process. The GUI process presents a display image including the order value fields, and the user provides the order value field data. Alternatively, the order parameter values are automatically defined by a preceding process to the current workflow process in the automatic ancillary ordering workflow.

The FIGS. 3A, 3B system operating architecture is further described by reference to one or more scenarios. In a first scenario, the WEE (10) and RE (20) provide for an automatic ancillary smoking consultation order by identifying a code in an assessment (order) identifying a patient as a smoker at risk (e.g., parameter value field XYZ=true (smoker at risk)). That is, where a nurse enters a patient assessment after marking the parameter value field XYZ=true (smoker at risk), the field is parsed and the code triggers automatic initiation of the smoking risk ancillary consult order. Put another way, the nurse saves the assessment and the system automatically finds the code and raises an event to the WFE to automatically place the ancillary consult order Manual user intervention is not required for the automatic ancillary consult order process. The WFE (10) and RE (20) call the auto orders auto place/update service API (30), which facilitates the ancillary ordering workflow.

The examples or scenarios presented relate to specific system operation for the exemplary facts. One scenario includes an admission whereby an admission worker accesses the system to “admit.” a mother to maternity for labor and delivery, and finds that the mother is diabetic. An code is entered in an admission record, for example, by setting a parameter value field “diabetic”=True (infant diabetic precaution). The system automatically raises an event when it parses the admission data and detects the code upon admission (order) entry. The WFE (20) and RE (10) respond to initiate an ancillary order workflow for the automatically ordered blood glucose tests. The API (30) collects order parameters as required by the WFE and RE to render decisions and advance the ancillary order workflow. This automatic operation is distinguished from the automatic creation and activation described above in association with the assessment event automatic order scenario.

In the scenario, the following ancillary orders to the admission order are placed and forwarded to the alerts worklist:
Blood glucose q15 minutes ×1 hr
Blood glucose q 30 min ×1 hr
Blood glucose qhr ×4 hr
Blood glucose daily until discharge

The WFE (10) and RE (20) send notification for API messaging to post suggested order actions or tasks on an alerts worklist. The alerts worklist informs healthcare facility workers of suggested action, and tracks ancillary order workflow. For example, an order task is communicated to a lab technician to perform the blood glucose tests to assess blood glucose level for the infant during the first hours of life. The API (30) call back strategies function (40) provides success and failure messages with specific error, warning and informational codes that the WFE (10) evaluates to determine next action in the ancillary order workflow. This includes skipping or overriding workflow steps based on detected events, to automatically execute the blood test orders and return test results.

In accord with the scenario, the API (30) marks each ancillary blood glucose test order with a protocol name: “diabetic precaution, infant” the ancillary orders. An attending physician field is automatically marked. The WFE uses a “sent duplicate override” flag to override duplicates processing, compelling the API to automatically skip or discontinue the duplicates operation while still initiating the order. For the Scenario, the WFE predefines frequencies of q 15 minutes and duration of 1 hr for first order, q 30 mins frequency and duration of 1 hr for second order, as suggested order tasks. The signature level requires cosignature by a clinician for the hourly blood glucose tests since they are more frequent for the infant, but the “daily until discharge” test (ancillary order) is more routine, so policy and does not require cosignature for the daily task.

The API evaluates the blood glucose test order requirements including duplicate orders checking, medical necessity checks, clinical checks, “needs to review” checks, and flag checks described above with standard order parameters function (50) workflow. Based on the parameter values passed back, the FE (10) makes further policy decisions, acting based on customer defined policies and protocols already approved by the institution. If the hospital policy requires additional step of acknowledge or wants to skip or force a cosignature, the WFE (10), RE (20) and API (30) interoperate to execute ordering workflow policy. That is, API (30) evaluates the blood glucose lab test order information by function (320) and finds no missing or invalid data; no message is sent back to the WFE (10). But if function (320) detects invalid or missing data, the API automatically sends a message to the WEE with the missing or invalid parameter field data. The WEE responds by determining whether to provide a default or to reprocess for the parameter (“try again”).

If the API (30) evaluates and finds validation error by function (325), it sends (passes) a message with the parameter back to the WFE (10) to determine whether to provide an update and try again. Examples of validation error data include a stop date/time (defaulted) found to fall before a start date/time, and an ordering frequency is detected as illogical. The WEE can process and skip entering the order and instead message the API to push the parameters raising the validation error to the alerts worklist to correct for the error to execute the suggested task. API (30) implements the duplicate order checking function (330) to determine if the WFE sent an override for a duplicate order. In the scenario, the blood glucose tests are not determined to be duplicates, no override is implemented, and no override message is returned to the WFE.

API (30) evaluates order medical necessity checking by the medical necessity function (335). Where the medical necessity check returns negative, the API returns a success message to the WFE, and continues the workflow. In the diabetic precaution, infant and related lab tests workflow scenario, the API performs medical necessity checking and sees that the automatic infant blood glucose test orders do not include medical necessity, and returns the success message to the WFE. But in a case where an order requires a medical necessity, such as requiring patient presence to sign an advanced beneficiary notice (ABN), the WFE redirects the order to an appropriate alerts worklist to alert a worker to provide the required intervention instead of auto placing the order. With no necessary intervention (as in the scenario), the API operates the “need review” function (340) to determine whether the automatic ancillary blood lest order information provided by the WFE includes a “need review” requirement (code). Because the automatic ancillary blood test order information does not indicate need to review an order, or if the information includes a “need review?” requirement and a WFE override, the automatic ancillary blood test order is processed by Output order processing function (60), as indicated by connectors B.

Output order processing function (60) evaluates the ancillary blood test order level of activation, level of signature required against WFE sign level to determine if inactive or active, and if an additional cosignature is required by function (355). Function (355) further evaluates the signature level to determine whether orders require cosignature or acknowledgement. Because no cosignature or acknowledge is needed for the ancillary blood glucose test orders, requirements for same do not appear on the automatic unsigned orders alerts worklist. If the blood glucose tests required clinician co-signature, an alert would be sent and appear on the unsigned orders alerts worklist by function (380). In the scenario, a cosignature by a clinician is required for the blood glucose hourly test orders, but not for the blood glucose daily test orders. That is, blood glucose hourly test orders show that the order is active, and an additional cosignature is required by a physician on the unsigned orders worklist.

For the ancillary blood test orders, function (360) evaluates whether the WEE sent an acknowledge flag to execute an override. Where no acknowledge (override) is sent, and the order service does not normally require acknowledge, so no message is sent to the acknowledge worklist by function (385). But if the WFE (10) had sent an override acknowledge flag, or the service (order) workflow normally requires it, function (385) messages the acknowledge worklist. The order is still active, but its execution requires the additional acknowledgement before the lab technician would nurse perform the test. The intervention worklist function (390) and other appropriate worklist function (395) are also operated to process the ancillary lab test orders by function (365) as described above.

Output order processing (60) flow passes to a run RE (20) select service (order) trigger function (375), with background indicator. If the ancillary lab test orders do not have other rules requirements, no additional rules are run in the background workflow. That is, WFE places the blood glucose test orders with the Output order processing, which implements the ancillary blood glucose test order processing without additional user interaction, including messaging to an appropriate alerts worklist. That is, the ancillary blood test order workflow alerts an appropriate sample collection worklist, waiting for the nurse to collect the results. The blood glucose hourly tests are included on the unsigned orders worklist for the legal cosignature by the physician. But as mentioned, facility policy based in the rules allows that the order can be carried out even without this additional cosignature, obviating need for manual review of the suggested “collecting” actions. Such system operation provides for efficient and timely patient care. Tracking orders is be implemented in association with an order ID assigned by the WFE in the order workflow process. The ancillary blood glucose test orders are functionally equivalent to all other system orders, including data for appropriate links to billing, details, history, etc.

In another ancillary order scenario, system operation responds to a physician's manual order for digoxin, IV daily ×7 days. The WFE (10) is configured to respond to a system defined event: write orders, such that upon determining that the digoxin order is placed, the system automatically places an ancillary order for apical heart rate, by the operation described above. The ancillary apical heart rate order directs appropriate healthcare workers to monitor pulse per the institution policies with the administration of the digoxin. The automatic ancillary apical heart rate order automatically shows on the intervention worklist for the nurse assigned to care for and treat the patient for whom the digoxin is ordered.

The examples or scenarios presented relate to specific system operation for the exemplary facts. The invention, however, is intended to respond to any event, order fields and parameter values to trigger automatic ancillary ordering operation, e.g., an admission event, a write order event, a save assessment event, a new result event, etc., which are triggered by any combination of multiple fields assesses, result values, and patient factors to determine order workflow. Other system modules, like radiology system modules may call the Orders Auto Place/Update Service API (30). The API enables other system modules to take advantage of interactive messaging instead using traditional store and forward engines from system to system. The interactive messaging enables the external system, or system module operation to adhere to institution policies implemented in the ordering workflow. In another scenario, an external radiology system performs a back x-ray on a patient and determines that an additional MRI is needed. By marking a field in the back x-ray assessment, and entry, the radiology system raises an event to which the WFE (10) responds, activating API (30) to add the MRI order as an automatic ancillary order. Radiology system is notified of the ancillary order via the WFE and RE messaging, e.g. by passing an order message to an appropriate MRI order alerts worklist.

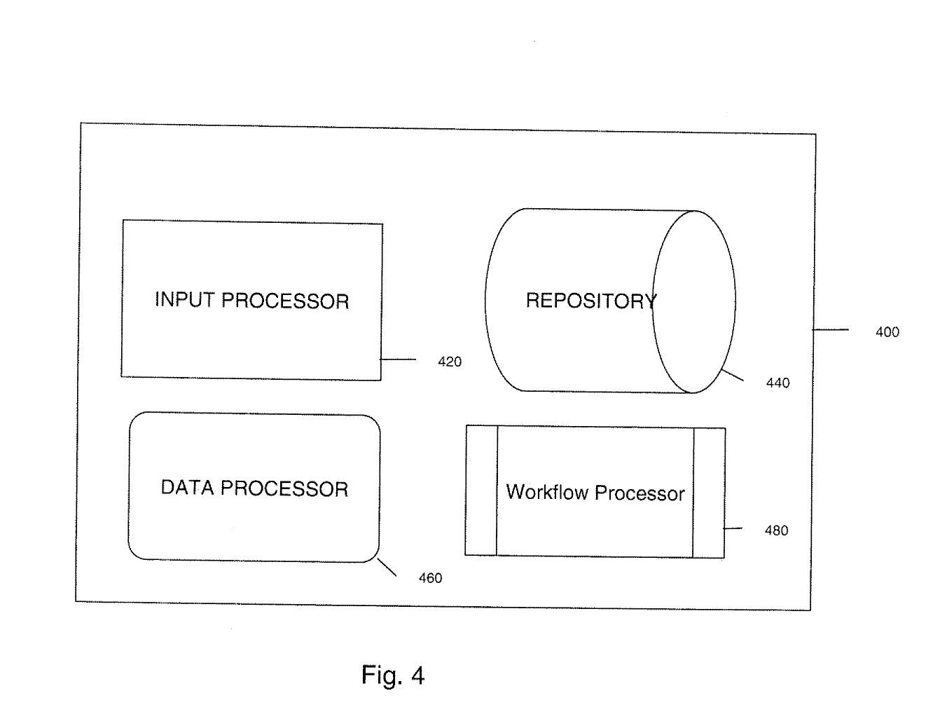

FIG. 4 shows an automated treatment ordering system (400). The system includes at least one repository of information (440) associating a plurality of orders for treatment to be administered to a patient with corresponding ancillary treatment orders for automatic initiation. Treatment may include patient services other than healthcare treatment orders. An input processor (420) receives data identifying initiation of a particular treatment order for a particular patient. A data processor (460) uses the information within the repository to automatically identify and initiate an ancillary treatment order associated with the particular treatment order for the patient in response to predetermined rules and the data identifying initiation of the particular treatment order. A workflow processor (480) automatically communicates a message to inform a healthcare worker of a task to be performed pursuant to the ancillary treatment order.

The ancillary treatment order is created and automatically activated such that the workflow processor automatically communicates the messaging without human intervention by execution in accordance with the predetermined rules and data processor (560) operation. The ancillary treatment orders comprise medication orders, admission orders, discharge orders, surgical orders, radiological orders, nursing treatment orders, dietary treatment orders, activity requests, consults, continuing consults, interventions, without limitation. The predetermined rules comprise hospital or facility policy. The predetermined rules may comprise any of (a) hospital determined procedures, (b) hospital determined treatment protocols and (c) treatment safety standards. The data processor identifies a code representing the particular treatment order by parsing data fields of a record representing the particular treatment order, using the identified code to automatically identify the ancillary treatment order from the information in the at least one repository.

Although a few examples of the present invention are shown and described, it would be appreciated by those skilled in the art that changes may be made in these embodiments without departing from the principles and spirit of the invention, the scope of which is defined in the claims and their equivalents.

What is claimed is:

1. An automated treatment ordering system, comprising:
at least one repository including information associating a plurality of orders for treatment to be administered to a patient with corresponding ancillary treatment orders;
an input processor for receiving data identifying initiation of a particular treatment order for a particular patient;
a data processor for using said information in said at least one repository for automatically identifying and initiating an ancillary treatment order associated with said particular treatment order for said particular patient in response to predetermined rules and said data identifying initiation of said particular treatment order; and
a workflow processor for automatically communicating a message to inform a healthcare worker of a task to be performed in performance of said ancillary treatment order.

2. A system according to claim 1, wherein
said data processor automatically identifies and initiates said ancillary treatment order and said workflow processor automatically communicates said message without human intervention in response to execution of said predetermined rules.

3. A system according to claim 1, wherein
said ancillary treatment orders comprise any of said plurality of orders for treatment.

4. A system according to claim 1, wherein
said ancillary treatment orders comprise at least one of, (a) a nursing treatment order, (b) a dietary treatment order, (c) a nutrition related treatment order and (d) a non-order suggested directive.

5. A system according to claim 1, wherein
said predetermined rules comprise hospital policies.

6. A system according to claim 1, wherein
said predetermined rules comprise at least one of, (a) hospital determined procedures, (b) hospital determined treatment protocols and (c) treatment safety standards.

7. A system according to claim 1, wherein
said data processor identifies a code representing said particular treatment order by parsing data fields of a record representing said particular treatment order and uses said identified code in automatically identifying said ancillary treatment order from said information in said at least one repository.

8. A system according to claim 7, wherein
said workflow processor implements an order workflow for said identified ancillary treatment order.

9. An automated treatment ordering system, comprising:
at least one repository including information associating a plurality of orders for treatment to be administered to a patient with corresponding ancillary treatment orders;
an input processor for receiving data indicating a diagnostic patient assessment has been made;
a data processor for automatically parsing and examining data fields of a document comprising said diagnostic patient assessment to derive a code representing said particular treatment order and using said identified code in automatically identifying said ancillary treatment order from said information in said at least one repository; and
a workflow processor for automatically communicating a message to inform a healthcare worker of a task to be performed in performance of said ancillary treatment order.

10. A system according to claim 9, wherein
said workflow processor automatically communicates said message to update a worklist of said healthcare worker with data indicating said task to be performed in performance of said ancillary treatment order.

11. An automated treatment ordering system, comprising:
at least one repository including information associating a plurality of orders for treatment to be administered to a patient with corresponding ancillary treatment orders;
an input processor for receiving data identifying initiation of a particular treatment order for a particular patient;
a data processor for using said information in said at least one repository for automatically identifying and initiating an ancillary treatment order associated with said particular treatment order for said particular patient in response to said data identifying initiation of said particular treatment order; and
a workflow processor for automatically communicating a message to inform a healthcare worker of a task to be performed in performance of said ancillary treatment order.

12. A system according to claim 11, wherein
said information in said at least one repository comprises predetermined rules used for automatically associating said plurality of orders for treatment to be administered to a patient to indicate said corresponding ancillary treatment orders associated with said associated plurality of orders for treatment.

13. A system according to claim 11, wherein
said workflow processor responds to the data processor to control various workflow processes including said communicating.

14. A method for automatically identifying and activating ancillary orders by a medical treatment ordering system in response to detected ancillary order codes, the method comprising the steps of:
parsing data fields included in a treatment order to detect an ancillary order code;
where an ancillary order code is detected, automatically identifying an ancillary order associated with the detected code; and
executing ancillary order workflow including automatically collecting ancillary order parameter values and initiating the ancillary order by messaging an alerts worklist accessible by supporting healthcare workers.

15. A computer program product, comprising:
a tangible storage medium readable by a processing circuit and storing instructions for execution by the processing circuit for performing a method as set forth in claim 14.
